(19) United States
(12) Patent Application Publication
(10) Pub. No.: US 2005/0155478 A1
(43) Pub. Date: Jul. 21, 2005

(54) Nicked cutting rule

(75) Inventor: Gregory R. Zimmer, Hawthorne, NJ (US)

Correspondence Address: BURNS DOANE SWECKER & MATHIS L L P, POST OFFICE BOX 1404, ALEXANDRIA, VA, 22313-1404, US

(73) Assignee: AB SANDVIK MATERIALS TECHNOLOGY,, Sandviken (SE)

(21) Appl. No.: 10/760,484

(22) Filed: Jan. 21, 2004

(51) Int. Cl. B26D 1/00

(52) U.S. Cl. 83/695; 76/107.8

(57) ABSTRACT

A nicked cutting rule includes a shank portion having two substantially parallel shank side surfaces extending in a direction of length of the rule separated by a thickness of the shank portion. The nicked cutting rule further includes a V-shaped cutting edge portion defined by two cutting edge portion surfaces that intersect at ends remote from the shank portion to define a cutting edge, the cutting edge portion having portions separated in the direction of length of the rule by a plurality of notches extending inwardly from the cutting edge toward the shank portion. The nicked cutting rule also includes an intermediate portion between and integral with the shank portion and the cutting edge portion, the intermediate portion being thinner than the thickness of the shank portion and including two intermediate portion surfaces extending between the two shank side surfaces and the two cutting edge portion surfaces. A hardness of the shank portion, a hardness of the cutting edge portion, the thickness of the shank portion, and the thicknesses of the intermediate portion and the cutting edge portion are selected such that the nicked cutting rule is bendable.

### BACKGROUND AND SUMMARY

The present invention relates to a nicked cutting rule and, more particularly, to a highly bendable nicked cutting rule.

In conventional cutting rules, the rule includes a shank portion that has substantially parallel sides and a V-shaped cutting portion along an edge of the shank portion. Hardening by heat treatment of all or part of such a rule such as at the cutting edge increases durability of the rule, but makes it less capable of bending. Bendability of a rule is generally defined as the smallest achievable bending radius without failure. Thus, where it is desired to provide a non-rectilinear cut or perforation in, for example, paper or plastic stock, it has been customary to use rules without the heat treatment that is used on straight segments. The rules without the heat treatment are more bendable but less durable.

U.S. Pat. No. 3,411,208, the disclosure of which is incorporated by reference, discloses a steel cutting strip having a main strip portion of substantially uniform hardness throughout but which is readily deformable so that it may be bent to form corners of low radii, and a cutting edge integral with the main body portion and of much greater hardness, but also of substantially uniform hardness throughout. The cutting edge portion is connected to the main strip by a thin layer integral with both the main strip portion and the cutting edge portion. With this arrangement, the cutting edge is sufficiently small to permit it to be bent without damage, even though it is extremely hard, and the bond to the main strip portion remains intact. Commercial embodiments of cutting strips made according to this patent include SANDVIK DIEFLEX edge-hardened cutting and scoring rules, available from Sandvik Steel Inc., 1702 Nevins Road, Fair Lawn, NJ.

U.S. Pat. No. 5,537,905, the disclosure of which is incorporated by reference, discloses a nicked cutting rule that improves upon conventional rules by providing an intermediate portion between a V-shaped cutting portion and a shank portion of the rule, where the intermediate portion is thinner than the shank portion. In one embodiment of the nicked cutting rule, the sides of the cutting portion taper inwardly from the shank having parallel sides toward a cutting edge of the rule. In another embodiment, the cutting portion has parallel sides like the shank, but is thinner than the shank. If the rule is heat treated proximate to the cutting edge to harden the rule material, the nicked cutting rule has improved bendability relative to the prior art because the thinner intermediate portion is more flexible than a corresponding, thicker portion in a conventional rule. A commercial embodiment of a nicked cutting rule according to this patent is the MICRONIK cutting rule available from Zimmer Industries, Inc., 200 Central Ave., P.O. Box 16, Hawthorne, NJ 07507-0016.

Nonetheless, it has been found that, even with the improvements described in U.S. Pat. No. 5,537,905, obtaining desired bendability characteristics is difficult. Ordinarily, when such a rule prepared using conventional heat treating techniques is bent, the bevel at the cutting edge tends to distort, particularly where there are nicks. Accordingly, it has become common to simply omit nicks in areas of the rule that must be bent around tight radii. Even around larger radii, the presence of the nicks in such products tends to limit bendability of the rule material to form coils, which is a form in which rule material is manufactured, stored, and shipped.

According to an aspect of the present invention, a nicked cutting rule includes a shank portion having two substantially parallel shank side surfaces extending in a direction of length of the rule separated by a thickness of the shank portion. The nicked cutting rule further includes a V-shaped cutting edge portion defined by two cutting edge portion surfaces that intersect at ends remote from the shank portion to define a cutting edge, the cutting edge portion having portions separated in the direction of length of the rule by a plurality of notches extending inwardly from the cutting edge toward the shank portion. The nicked cutting rule also includes an intermediate portion between and integral with the shank portion and the cutting edge portion, the intermediate portion being thinner than the thickness of the shank portion and including two intermediate portion surfaces extending between the two shank side surfaces and the two cutting edge portion surfaces. The thickness of the shank portion is from about 0.718 to about 2.13 mm, the shank portion has a hardness between about 280 and 450 HV, and the cutting edge portion has a hardness between about 480 to 720 HV.

According to another aspect of the present invention, a nicked cutting rule includes a shank portion having two substantially parallel shank side surfaces extending in a direction of length of the rule separated by a thickness of the shank portion. The nicked cutting rule further includes a V-shaped cutting edge portion defined by two cutting edge portion surfaces that intersect at ends remote from the shank portion to define a cutting edge, the cutting edge portion having portions separated in the direction of length of the rule by a plurality of notches extending inwardly from the cutting edge toward the shank portion. The nicked cutting rule also includes an intermediate portion between and integral with the shank portion and the cutting edge portion, the intermediate portion being thinner than the thickness of the shank portion and including two intermediate portion surfaces extending between the two shank side surfaces and the two cutting edge portion surfaces. A hardness of the shank portion, a hardness of the cutting edge portion, the thickness of the shank portion, and the thicknesses of the intermediate portion and the cutting edge portion are selected such that the nicked cutting rule is bendable to 150° at a radius of 0.35 mm.

According to another aspect of the present invention, a process for producing a nicked cutting rule is provided. According to the process, a hot rolled strip is subjected to decarburization annealing. The strip is cold rolled to a thickness of from about 0.178 to about 2.13 mm. The cold rolled strip is subjected to hardening and tempering so that the strip has a hardness between about 280 and 450 HV. The hardened and tempered strip is slit to form one or more rules of a desired height. An edge of a rule is processed to form a V-shaped cutting edge portion having two surfaces that intersect to form a cutting edge, an unprocessed shank portion having two substantially parallel surfaces separated by a shank thickness, and an intermediate portion between the cutting edge portion and the shank portion having two surfaces connecting the two surfaces of the cutting edge portion and the two surfaces of the shank portion, the intermediate portion being thinner than the shank thickness. The cutting edge portion is edge hardened to a hardness between about 480 to 720 HV. A plurality of notches extending inwardly from the cutting edge toward the shank portion is provided in the cutting edge portion to define a nicked cutting rule wherein portions of the cutting edge are separated in the direction of length of the rule by the notches.

According to still another aspect of the invention, a process for producing a nicked cutting rule is provided. According to the process, a hot rolled strip is subjected to decarburization annealing. The strip is cold rolled to a desired shank thickness. The cold rolled strip is subjected to hardening and tempering so that the strip has a desired shank hardness. The hardened and tempered strip is slit to form one or more rules of a desired height. An edge of a rule is processed to form a V-shaped cutting edge portion having two surfaces that intersect to form a cutting edge, an unprocessed shank portion having two substantially parallel surfaces separated by the shank thickness, and an intermediate portion between the cutting edge portion and the shank portion having two surfaces connecting the two surfaces of the cutting edge portion and the two surfaces of the shank portion, the intermediate portion being thinner than the shank thickness. The cutting edge portion is edge hardened to a desired cutting edge hardness. A plurality of notches extending inwardly from the cutting edge toward the shank portion is provided in the cutting edge portion to define a nicked cutting rule wherein portions of the cutting edge are separated in the direction of length of the rule by the notches. The edge of the rule is mechanically processed so that the cutting edge portion and the intermediate portion are sufficiently thin, and the shank thickness, the shank hardness, and the cutting edge hardness are such that the nicked cutting rule is bendable to 150° at a radius of 0.35 mm.

### BRIEF DESCRIPTION OF THE DRAWINGS

The features and advantages of the present invention are well understood by reading the following detailed description in conjunction with the drawings in which like numerals indicate similar elements and in which:

FIG. 1 is a cross-sectional side view of a nicked cutting rule according to an embodiment of the present invention;

FIG. 2 is a perspective view of a nicked cutting rule according to an embodiment of the present invention; and

FIGS. 3a and 3b are diagrams of embodiments of steps in a process for making a nicked cutting rule according to the present invention.

### DETAILED DESCRIPTION

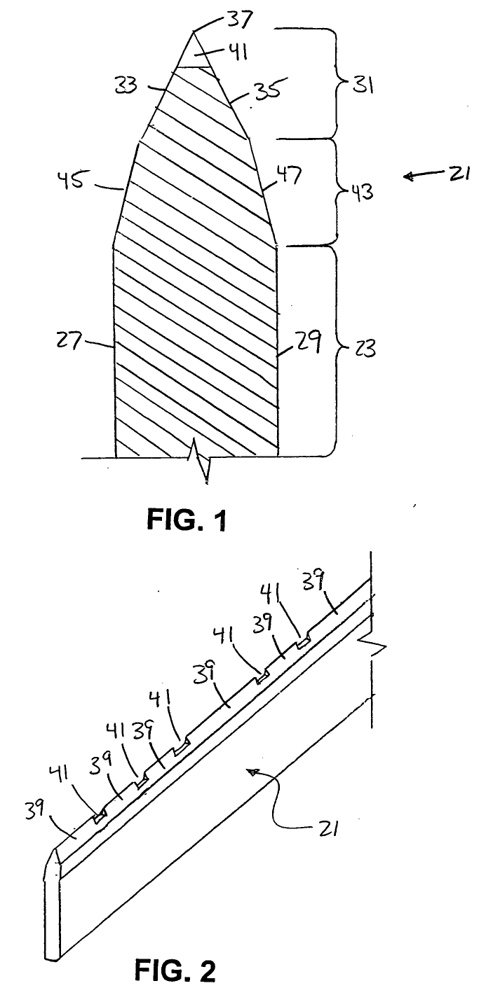

FIG. 1 shows a nicked cutting rule 21 according to an embodiment of the present invention. The nicked cutting rule 21 includes a shank portion 23 having two substantially parallel shank side surfaces 27 and 29 extending in a direction of length of the rule separated by a thickness of the shank portion. The nicked cutting rule 21 also includes a V-shaped cutting edge portion 31 defined by two cutting edge portion surfaces 33 and 35 that intersect at ends remote from the shank portion 23 to define a cutting edge 37.

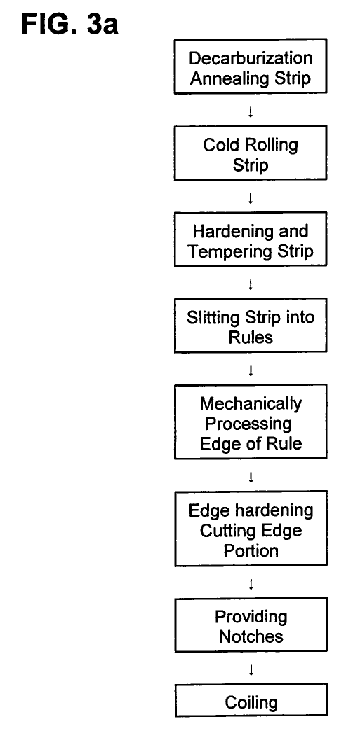

As seen in FIG. 2, the cutting edge portion 31 has portions 39 separated in the direction of length of the rule 21 by a plurality of notches 41 extending inwardly from the cutting edge toward the shank portion. The cutting rule 21 further includes an intermediate portion 43 between and integral with the shank portion 23 and the cutting edge portion 31. The intermediate portion 43 is thinner than the thickness of the shank portion 23 and includes two intermediate portion surfaces 45 and 47 extending between the two shank side surfaces 27 and 29 and the two cutting edge portion surfaces 33 and 35.

In a preferred embodiment, the thickness of the shank portion 23 is from about 0.178 to about 2.13, preferably from about 0.355 to about 1.42, most preferably from about 0.71 to about 1.05, mm, the shank portion has a hardness between about 280 and 450 HV, and the cutting edge portion 31 has a hardness between about 480 to 720 HV. The cutting edge portion 31 and the intermediate portion 43 are processed to thicknesses such that the nicked cutting rule 21 is bendable to an extent dependent on thickness. That is, for a nicked cutting rule having a thickness of from about 0.178 to about 0.710 mm, the rule is bendable to 150° at a radius of 0.35 mm. For a nicked cutting rule having a thickness of about 1.05 mm, the rule is bendable to 100° at a radius of 0.35 mm and for a nicked cutting rule having a thickness of from about 1.42 to about 2.13 mm, the rule is bendable to 1050 at a radius of 1.0 mm. According to one embodiment of the present invention, the shank portion has a thickness of 0.71 mm and a hardness of about 380 HV and the cutting edge portion has a hardness about 640 HV.

According to an embodiment of the invention, at least one of the cutting edge portion 31 and the intermediate portion 43 have shaved surfaces. The cutting edge portion 31 may have ground surfaces 33 and 35 and the intermediate portion 43 may have shaved surfaces 45 and 47. The cutting edge portion 31 may have ground surfaces 33 and 35 even if the intermediate portion 43 does not have shaved surfaces 45 and 47.

Distances between pairs of succeeding notches 41 may be the same or different. It may be desirable in specialty rules, for example, to not include notches 41 at locations along the rule where it is known that the rule will be bent through a particularly tight radius.

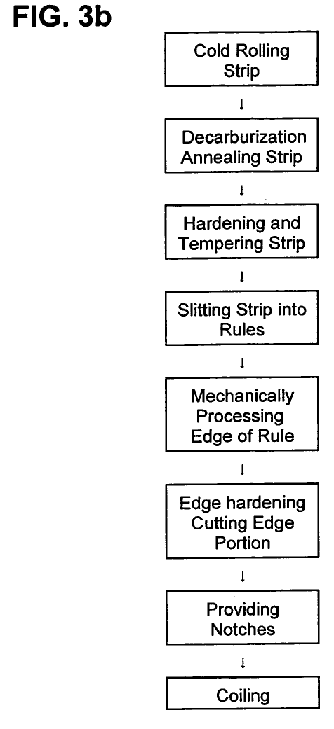

A process for producing a nicked cutting rule 21 according to the present invention is seen in FIG. 3a. The process includes subjecting a hot rolled strip to decarburization annealing. Preferably, decarburization annealing provides a strip having a lower surface hardness than the hardness at the center of the strip to enhance bendability, for example, about 150 HV lower. The strip is cold rolled to the desired thickness. In the process according to FIG. 3a, the strip is cold rolled after decarburization annealing.

The cold rolled strip is subjected to hardening and tempering giving a bainitic microstructure so that the strip has a hardness between about 280 and 450 HV. After hardening and tempering the difference between hardness at the surface and hardness at the center is somewhat greater than after decarburization annealing, such as about 200 HV, where surface hardness is 180 HV and center hardness is 380 HV. The hardened and tempered strip is slit to form one or more rules of a desired height. Referring now also to FIGS. 1 and 2, an edge of a rule 21 is processed to form a V-shaped cutting edge portion 31 having two surfaces 33, 35 that intersect to form a cutting edge 37, an unprocessed shank portion 23 having two substantially parallel surfaces 27, 29 separated by a shank thickness, and an intermediate portion 43 between the cutting edge portion and the shank portion having two surfaces 45, 47 connecting the two surfaces of the cutting edge portion and the two surfaces of the shank portion, the intermediate portion being thinner than the shank thickness.

The cutting edge portion 31 is edge hardened to a hardness between about 480 to 720 HV. A plurality of notches 41 extending inwardly from the cutting edge 37 toward the shank portion is provided in the cutting edge portion to define a nicked cutting rule 21 wherein portions 39 of the cutting edge are separated in the direction of length of the rule by the notches. The edge of the rule 21 is processed so that the cutting edge portion 31 and the intermediate portion 43 are sufficiently thin so that the nicked cutting rule is bendable to the degree and at the radius for that thickness as given above.

According to one embodiment of the invention, at least one of the surfaces 33 and 35 of the cutting edge portion 31 and the surfaces 45 and 47 of the intermediate portion 43 are processed by shaving. The surfaces 33 and 35 of the cutting edge portion 31 may be processed by grinding, and the surfaces 45 and 47 of the intermediate portion 43 may be shaved, or not shaved, as desired or necessary.

The notches 41 can be provided in a variety of ways, such as by wire EDM, by grinding, and by punching. Punching is generally preferred when accuracy is less important than speed of manufacture and depth of the notches 41, while wire EDM or grinding are generally preferred for higher accuracy. The distances between any two pairs of succeeding notches 41 may be made different. It may, for example, be beneficial to not have notches in particular areas where it is known that a blade will be bent around a particularly tight radius.

A nicked cutting rule 21 according to the present invention is particularly well-suited for coiling for storage or shipment purposes.

In an alternative process shown in FIG. 3b, the cold rolling step can be performed before the decarburization annealing step. Also, if desired or necessary, decarburization annealing can be performed together with hardening and tempering of the strip.

While this invention has been illustrated and described in accordance with a preferred embodiment, it is recognized that variations and changes may be made therein without departing from the invention as set forth in the claims.

1. A nicked cutting rule, comprising:
a shank portion having two substantially parallel shank side surfaces extending in a direction of length of the rule separated by a thickness of the shank portion;
a V-shaped cutting edge portion defined by two cutting edge portion surfaces that intersect at ends remote from the shank portion to define a cutting edge, the cutting edge portion having portions separated in the direction of length of the rule by a plurality of notches extending inwardly from the cutting edge toward the shank portion;
an intermediate portion between and integral with the shank portion and the cutting edge portion, the intermediate portion being thinner than the thickness of the shank portion and including two intermediate portion surfaces extending between the two shank side surfaces and the two cutting edge portion surfaces;
wherein the thickness of the shank portion is from about 0.178 to 2.13 mm, the shank portion has a hardness between about 280 and 450 HV, and the cutting edge portion has a hardness between about 480 to 720 HV.

2. The nicked cutting rule as set forth in claim 1, wherein the shank portion has a thickness of about 0.71 mm and a hardness about 380 HV, the cutting edge portion has a hardness about 640 HV and the nicked cutting rule is bendable to 150° at a radius of 0.35 mm.

3. The nicked cutting rule as set forth in claim 1 wherein the shank portion has a thickness of from about 0.178 to about 0.710 mm.

4. The nicked cutting rule as set forth in claim 1 wherein the shank portion has a thickness of from about 1.05 mm.

5. The nicked cutting rule as set forth in claim 1 wherein the shank portion has a thickness of from about 1.42 to about 2.13 mm.

6. The nicked cutting rule as set forth in claim 1, wherein at least one of the cutting edge portion and the intermediate portion have shaved surfaces.

7. The nicked cutting rule as set forth in claim 1, wherein the cutting edge portion has ground surfaces.

8. The nicked cutting rule as set forth in claim 1, wherein distances between at least two pairs of succeeding notches are different.

9. The nicked cutting rule as set forth in claim 1, wherein the shank portion has a lower hardness at a surface of the shank portion than at a center of the shank portion.

10. A nicked cutting rule, comprising:
a shank portion having two substantially parallel shank side surfaces extending in a direction of length of the rule separated by a thickness of the shank portion;
a V-shaped cutting edge portion defined by two cutting edge portion surfaces that intersect at ends remote from the shank portion to define a cutting edge, the cutting edge portion having portions separated in the direction of length of the rule by a plurality of notches extending inwardly from the cutting edge toward the shank portion;
an intermediate portion between and integral with the shank portion and the cutting edge portion, the intermediate portion being thinner than the thickness of the shank portion and including two intermediate portion surfaces extending between the two shank side surfaces and the two cutting edge portion surfaces;
wherein a hardness of the shank portion, a hardness of the cutting edge portion, the thickness of the shank portion, and the thicknesses of the intermediate portion and the cutting edge portion are selected such that the nicked cutting rule is bendable to 150° at a radius of 0.35 mm.

11. A process for producing a nicked cutting rule, comprising:
subjecting a hot rolled strip to decarburization annealing;
cold rolling the strip to a thickness of about 0.71 mm;
subjecting the cold rolled strip to hardening and tempering so that the strip has a hardness between about 280 and 450 HV;
slitting the hardened and tempered strip to form one or more rules of a desired height;
processing an edge of a rule to form a V-shaped cutting edge portion having two surfaces that intersect to form a cutting edge, an unprocessed shank portion having two substantially parallel surfaces separated by a shank thickness, and an intermediate portion between the cutting edge portion and the shank portion having two surfaces connecting the two surfaces of the cutting edge portion and the two surfaces of the shank portion, the intermediate portion being thinner than the shank thickness;
edge hardening the cutting edge portion to a hardness between about 480 to 720 HV; and
providing a plurality of notches extending inwardly from the cutting edge toward the shank portion in the cutting edge portion to define a nicked cutting rule wherein portions of the cutting edge are separated in the direction of length of the rule by the notches.

12. The process as set forth in claim 11, wherein at least one of the surfaces of the cutting edge portion and the surfaces of the intermediate portion are processed by shaving.

13. The process as set forth in claim 12, wherein the surfaces of the cutting edge portion are processed by grinding.

14. The process as set forth in claim 11 wherein the surfaces of the cutting edge portion are processed by grinding.

15. The process as set forth in claim 11, wherein the notches are provided by wire EDM.

16. The process as set forth in claim 11, wherein the notches are provided by grinding.

17. The process as set forth in claim 11, wherein the notches are provided by punching.

18. The process as set forth in claim 11, wherein distances between at least two pairs of succeeding notches are different.

19. The process as set forth in claim 11, wherein the strip is cold rolled after decarburization annealing.

20. The process as set forth in claim 11, wherein the strip is cold rolled before decarburization annealing.

21. The process as set forth in claim 20, wherein decarburization annealing is performed at the same time as hardening and tempering.

22. The process as set forth in claim 20, wherein, after hardening and tempering, the strip has a lower hardness at a surface thereof than at a center of thereof.

23. A process for producing a nicked cutting rule, comprising:
subjecting a hot rolled strip to decarburization annealing;
cold rolling the strip to a desired shank thickness;
subjecting the cold rolled strip to hardening and tempering so that the strip has a desired shank hardness;
slitting the hardened and tempered strip to form one or more rules of a desired height;
processing an edge of a rule to form a V-shaped cutting edge portion having two surfaces that intersect to form a cutting edge, an unprocessed shank portion having two substantially parallel surfaces separated by the shank thickness, and an intermediate portion between the cutting edge portion and the shank portion having two surfaces connecting the two surfaces of the cutting edge portion and the two surfaces of the shank portion, the intermediate portion being thinner than the shank thickness;
edge hardening the cutting edge portion to a desired cutting edge hardness; and
providing a plurality of notches extending inwardly from the cutting edge toward the shank portion in the cutting edge portion to define a nicked cutting rule wherein portions of the cutting edge are separated in the direction of length of the rule by the notches,
wherein the edge of the rule is mechanically processed so that the cutting edge portion and the intermediate portion are sufficiently thin, and the shank thickness, the shank hardness, and the cutting edge hardness are such that the nicked cutting rule is bendable to 150E at a radius of 0.35 mm.

24. The process as set forth in claim 23, wherein at least one of the surfaces of the cutting edge portion and the surfaces of the intermediate portion are processed by shaving.

25. The process as set forth in claim 24, wherein the surfaces of the cutting edge portion are processed by grinding.

26. The process as set forth in claim 23, wherein the surfaces of the cutting edge portion are processed by grinding.

27. The process as set forth in claim 23, wherein the strip is cold rolled after decarburization annealing.

28. The process as set forth in claim 23, wherein the strip is cold rolled before decarburization annealing.

29. The process as set forth in claim 28, wherein decarburization annealing is performed at the same time as hardening and tempering.

30. The process as set forth in claim 23, wherein, after hardening and tempering, the strip has a lower hardness at a surface thereof than at a center of thereof.
